(19) United States
(12) Patent Application Publication
(10) Pub. No.: US 2017/0101754 A1
(43) Pub. Date: Apr. 13, 2017

(54) SNOW SCRAPING SHOVEL

(71) Applicant: ZHEJIANG YAT ELECTRICAL APPLIANCE CO., LTD, Zhejiang (CN)

(72) Inventors: Jun ZHOU, Zhejiang (CN); Haipeng LU, Zhejiang (CN)

(73) Assignee: ZHEJIANG YAT ELECTRICAL APPLIANCE CO., LTD, Zhejiang (CN)

(21) Appl. No.: 15/384,328

(22) Filed: Dec. 20, 2016

Related U.S. Application Data
(63) Continuation of application No. PCT/CN2015/082048, filed on Jun. 23, 2015.

(30) Foreign Application Priority Data
Mar. 24, 2015 (CN) 201510130059.7

(51) Int. Cl. E01H 5/02; F21V 23/04; F21V 31/00; F21V 33/00

(52) U.S. Cl. CPC E01H 5/02; F21V 33/0084; F21V 23/04; F21V 31/005; F21Y 2115/10

(57) ABSTRACT

An LED lamp is mounted on a snow scraping shovel. The LED lamp includes a front panel and a back panel which are jointly fixed. Foam is provided between the front panel and the back panel. A battery and a PCB board are provided in the space between the front panel, the back panel and the foam. The PCB board is connected with the battery by a wire. An LED is mounted on the PCB board. A light concentrating assembly formed by a light concentrating cover and a front LENS and a back LENS is provided outside of the LED. A switch for controlling the LED lamp is connected on the back panel.

### CROSS-REFERENCE TO RELATED APPLICATION

This application is a continuation of PCT application serial no. PCT/CN2015/082048, filed on Jun. 23, 2015, which claims priority to and the benefit of China Patent Application No. CN2015101300059.7, filed on Mar. 24, 2015, the disclosure of which is incorporated herein by reference in its entirety.

### TECHNICAL FIELD

The invention relates to a snow scraping shovel.

### BACKGROUND

The traditional snow scraping shovel has no illumination function so that it cannot be used at night.

### SUMMARY

The technical problem to be solved by the invention is to provide a snow scraping shovel which has an illumination function so as to be used at night conveniently.

To solve the above technical problem, the invention uses the following technical solution: a snow scraping shovel, wherein an LED lamp is mounted on the snow scraping shovel, the LED lamp comprises a front panel and a back panel which are jointly fixed, foam is provided between the front panel and the back panel, a battery and a PCB board are provided in the space between the front panel, the back panel and the foam, the PCB board is connected with the battery by a wire, an LED is mounted on the PCB board, a light concentrating assembly formed by a light concentrating cover and a front LENS and a back LENS is provided outside of the LED, and a switch for controlling the LED lamp is connected on the back panel.

Preferably, a convex seam allowance is provided on the front LENS, a concave seam allowance is provided on the back LENS, the convex seam allowance and the concave seam allowance are assembled in a matching way, and the convex seam allowance is covered with an O-ring for sealing.

Preferably, the switch is a push button switch which is provided with a middle gear, a normally on gear and a flicker gear, a magnetic steel is provided in the push button switch, and each of the corresponding normally on gear and the flicker gear of the push button switch is provided with a reed switch.

Preferably, the battery is provided in a battery case which is sealed by a battery cover, and the battery cover is covered with an O-ring for sealing.

Preferably, the LED lamp is connected with the snow scraping shovel by a handle assembly.

Preferably, the handle assembly comprises a front joint, a back joint and a connecting rod, the front joint is mounted on the LED lamp, the back joint is mounted on the snow scraping shovel, and the connecting rod is mounted between the front joint and the back joint.

The invention combines the LED and the traditional snow scraping shovel efficiently. Meanwhile, the LED has a flashing function so as to be used at night conveniently.

### BRIEF DESCRIPTION OF THE DRAWINGS

The invention will be further described in combination with the accompanying drawings and specific embodiments:

FIG. 1 shows an overall structural diagram I of the invention;

FIG. 2 shows an overall structural diagram II of the invention;

FIG. 3 shows a schematic diagram of A-A cross section illustrated in FIG. 1; and

FIG. 4 shows a structural diagram of axial cross section illustrated in FIG. 1.

### DETAILED DESCRIPTION

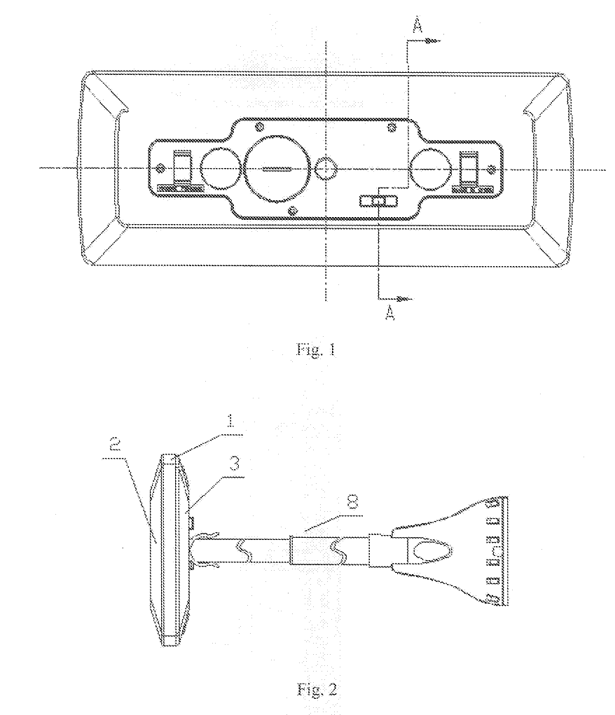

As shown in FIGS. 1 to 4, a snow scraping shovel is provided, wherein an LED lamp is mounted on the snow scraping shovel, the LED lamp comprises a front panel 2 and a back panel 3 which are jointly fixed, and foam 1 is provided between the front panel and the back panel. As shown in FIG. 4, a battery 11 and a PCB board 6 are provided in the space between the front panel, the back panel and the foam, the PCB board is connected with the battery by a wire, an LED is mounted on the PCB board, a light concentrating assembly formed by a light concentrating cover 5 and a front LENS 13 and a back LENS 12 is provided outside of the LED, and a switch for controlling the LED lamp is connected on the back panel. The LED lamp concentrates light through the light concentrating cover and the front LENS and the back LENS. The on/off or flicker of the LED is controlled by the switch.

A convex seam allowance is provided on the front LENS, a concave seam allowance is provided on the back LENS, and the convex seam allowance and the concave seam allowance are assembled in a matching way. The battery is provided in a battery case which is sealed by a battery cover 10. Since the snow scraping shovel has a special purpose and the water-proof performance should be taken into account, the convex seam allowance is covered with a first O-ring 4 for sealing, a second O-ring 7 is provided between the front panel 2 and the back panel 3 and the PCB board for sealing, and the battery cover is covered with a third O-ring 9 for sealing.

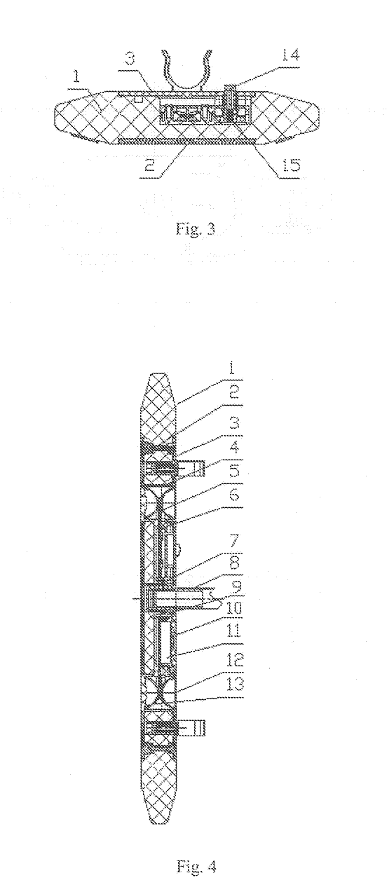

As shown in FIG. 3, the switch is a push button switch 14 which is provided with a middle gear, a normally on gear and a flicker gear, a magnetic steel 15 is provided in the push button switch, and each of the corresponding normally on gear and the flicker gear of the push button switch is provided with a reed switch. When the push button switch is in the middle gear, the LED on the PCB board assembly is in the normally off state. The push button switch is pushed to the normally on gear, the reed switch for controlling the normally on state is switched on, and the LED is in the normally on state. The push button switch is pushed to the flicker gear, the reed switch for controlling the flicker is switched on, and the LED is in the flicker state.

The LED lamp is connected with the snow scraping shovel by a handle assembly 8. The handle assembly comprises a front joint, a back joint and a connecting rod, the front joint is mounted on the LED lamp, the back joint is mounted on the snow scraping shovel, and the connecting rod is mounted between the front joint and the back joint. The LED lamp can be combined with or separated from the snow scraping shovel by the joints conveniently. The connecting rod has a stretchable rod structure, and the stretching length of the LED can be adjusted by the stretchable rod. Moreover, the handle assembly 8 is connected to the middle of the LED lamp. An LED and a corresponding light concentrating assembly are provided on either side of the LED lamp.

1. A snow scraping shovel, characterized in that: an LED lamp is mounted on the snow scraping shovel, the LED lamp comprises a front panel and a back panel which are jointly fixed, foam is provided between the front panel and the back panel, a battery and a PCB board are provided in the space between the front panel, the back panel and the foam, the PCB board is connected with the battery by a wire, an LED is mounted on the PCB board, a light concentrating assembly formed by a light concentrating cover and a front LENS and a back LENS is provided outside of the LED, and a switch for controlling the LED lamp is connected on the back panel.

2. The snow scraping shovel according to claim 1, wherein a convex seam allowance is provided on the front LENS, a concave seam allowance is provided on the back LENS, the convex seam allowance and the concave seam allowance are assembled in a matching way, and the convex seam allowance is covered with an O-ring for sealing.

3. The snow scraping shovel according to claim 1, wherein the switch is a push button switch which is provided with a middle gear, a normally on gear and a flicker gear, a magnetic steel is provided in the push button switch, and each of the corresponding normally on gear and the flicker gear of the push button switch is provided with a reed switch.

4. The snow scraping shovel according to claim 1, wherein the battery is provided in a battery case which is sealed by a battery cover, and the battery cover is covered with an O-ring for sealing.

5. The snow scraping shovel according to claim 1, wherein the LED lamp is connected with the snow scraping shovel by a handle assembly.

6. The snow scraping shovel according to claim 5, wherein the handle assembly comprises a front joint, a back joint and a connecting rod, the front joint is mounted on the LED lamp, the back joint is mounted on the snow scraping shovel, and the connecting rod is mounted between the front joint and the back joint.

7. The snow scraping shovel according to claim 2, wherein the LED lamp is connected with the snow scraping shovel by a handle assembly.

8. The snow scraping shovel according to claim 3, wherein the LED lamp is connected with the snow scraping shovel by a handle assembly.

9. The snow scraping shovel according to claim 4, wherein the LED lamp is connected with the snow scraping shovel by a handle assembly.

10. The snow scraping shovel according to claim 7, wherein the handle assembly comprises a front joint, a back joint and a connecting rod, the front joint is mounted on the LED lamp, the back joint is mounted on the snow scraping shovel, and the connecting rod is mounted between the front joint and the back joint.

11. The snow scraping shovel according to claim 8, wherein the handle assembly comprises a front joint, a back joint and a connecting rod, the front joint is mounted on the LED lamp, the back joint is mounted on the snow scraping shovel, and the connecting rod is mounted between the front joint and the back joint.

12. The snow scraping shovel according to claim 9, wherein the handle assembly comprises a front joint, a back joint and a connecting rod, the front joint is mounted on the LED lamp, the back joint is mounted on the snow scraping shovel, and the connecting rod is mounted between the front joint and the back joint.
